(19) United States
(12) Patent Application Publication
(10) Pub. No.: US 2012/0185092 A1
(43) Pub. Date: Jul. 19, 2012

(54) ROBOTIC ARM POSITION CONTROLLING DEVICE AND ROBOTIC ARM HAVING SAME

(75) Inventor: PING-HAN KU, Tu-Cheng (TW)

(73) Assignee: HON HAI PRECISION INDUSTRY CO., LTD., Tu-Cheng (TW)

(21) Appl. No.: 13/167,717

(22) Filed: Jun. 24, 2011

(30) Foreign Application Priority Data
Jan. 14, 2011 (TW) 100101459

(51) Int. Cl. B25J 13/08

(52) U.S. Cl. 700/258; 901/46; 901/9; 901/23; 901/24

(57) ABSTRACT

A robotic arm position controlling device includes a number of gyroscope sensors, an A/D convertor electrically connected to the gyroscope sensors, a storage connected to the A/D convertor and a processor. The gyroscope sensors each is configured for detecting and measuring movements of an arm segment and generating an analog signal associated with the detected movement of the arm segment. The A/D convertor is configured to convert the analog signal to digital signal. The storage is configured to store the converted digital signal and position information associated with predetermined positions of the arm segments. The processor is configured to determine the position of each of the arm segments based upon the converted digital, and determine of the position of each of the arm segments is deviated from the corresponding predetermined position, and control the driving motors to move the deviated arm segment to the predetermined position.

### BACKGROUND

1. Technical Field

The present disclosure relates to a robotic arm position controlling device and a robotic arm having the robotic arm position controlling device.

2. Description of Related Art

A robotic arm is employed to perform tasks that are too costly, difficult or dangerous to be performed by humans, such as welding, gripping, spinning etc. In order to accomplish the tasks, the robotic arm needs to be precisely positioned in time and space.

Many robotic arms are driven by linear motors, and the position information of the robotic arm is calculated based on the feedback of the linear motors. However, the feedback is in the form of linear signals, and rotation of robotic arms is calculated based on the linear signals using a predetermined algorithm that is not entirely precise, therefore, the accuracy of the calculated results may suffer.

What is needed therefore is a robotic arm position controlling device and a robotic arm addressing the limitations described.

### BRIEF DESCRIPTION OF THE DRAWINGS

The components of the drawings are not necessarily drawn to scale, the emphasis instead being placed upon clearly illustrating the principles of the embodiments of the robotic arm position controlling device and the robotic arm having the same. Moreover, in the drawings, like reference numerals designate corresponding parts throughout several views.

FIG. 1 is a schematic view of a robotic arm, according to an exemplary embodiment of the present disclosure.

FIG. 2 shows a block diagram of the robotic arm of FIG. 1.

### DETAILED DESCRIPTION

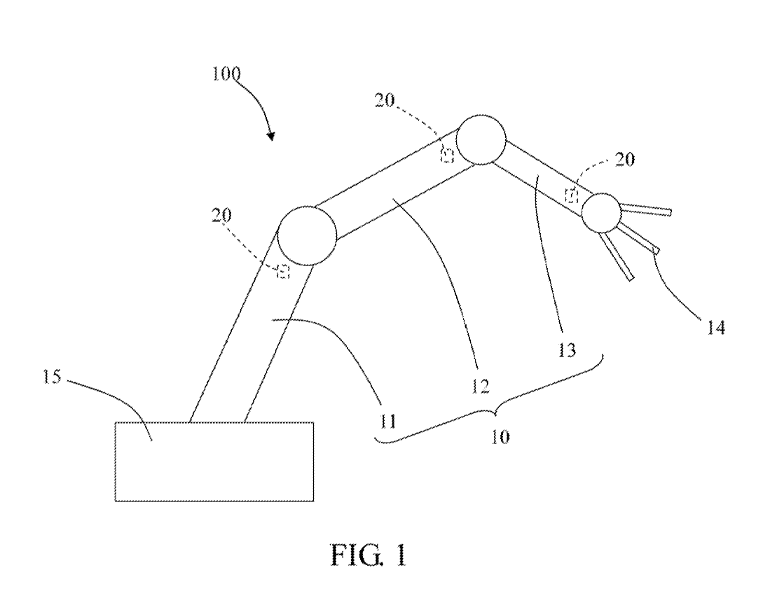

Referring to the FIG. 1, a robotic arm 100, according to an exemplary embodiment, is shown. The robotic arm 100 includes a number of articulated arm segments 10 and a number of gyroscope sensors 20 respectively fixed on the arm segments 10.

The arm segments 10 are movably connected to each other end to end. In this embodiment, the movable arms 10 includes a first arm segment 11, a second arm segment 12, and a third arm segment 13. One end of the first arm segment 11 is movably connected to a base 15, the other end of the first arm segment 11 is movably connected to an end of the second arm segment 12. One end of the third arm segment 13 is movably connected to the other end of the second arm segment 12, which is away from the first arm segment 11. The robotic arm 100 further include an operating head 14, the operating head 14 is configured for performing predetermined tasks, such as welding, gripping, spinning etc.

The gyroscope sensors 20 each is configured to detect and measure a movement of the corresponding arm segment 10 and generate an analog signal associated with the detect movement of the arm segment 10. Each gyroscope sensor 20 can detect movements in three-dimensions of the arm segment 10. In this embodiment, the number of the gyroscope sensors 20 corresponds to that of the arm segment 10, and each gyroscope sensor is mounted on the corresponding arm segment 10 adjacent to a distal end thereof.

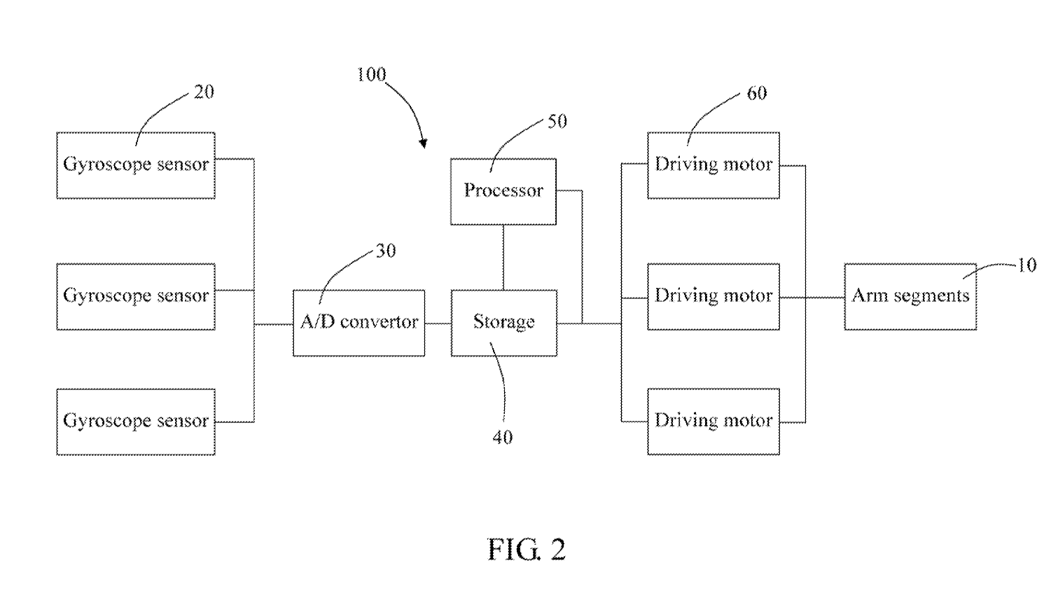

Referring to FIG. 2, the robotic arm 100 further includes an analog to digital (A/D) convertor 30, a storage 40, a processor 50, and a number of driving motors 60.

The A/D convertor 30 is electrically connected to the gyroscope sensors 20 and configured to convert the analog signals to digital signals.

The storage 40 is connected to the A/D convertor 30 and configured to store the converted digital signal and position information associated with predetermined positions of the arm segments. The predetermined information includes position information of the robotic arm 100 and programs for controlling the driving motors 60.

The processor 50 is configured to calculate movements of the arm segments 10 to determine the position of the each of arm segments 10 at any given time based upon the converted digital signal, and determining if the position of each of the arm segments 10 is deviated from the corresponding predetermined position. The processor 50 then sends driving signals to the driving motors 60 if a deviation exists between the position of the arm segments 10 and the predetermined position. In detail, the processor 50 calculates the real position of the arm segments 10 based on the digital signals, determines a deviation of the arm segments 10 by comparing the real position and the predetermined position, then sends driving signals to the driving motors 60 for compensating for the deviation of positions of the arm segments 10.

The driving motors 60 are configured to drive the arm segments 10 to move. Based on the driving signals from the processor 50, the driving motors 60 drive the arm segments 10 to a position until precisely positioned according to the predetermined position information. In this embodiment, the diving motors 60 are stepping motors or linear motors.

In use, the processor 50 controls the driving motor to drive the arm segments 10 to a predetermined working position according to predetermined driving programs stored in the storage 40. At the same time, the gyroscope sensors 20 detect and measure the movements of the arm segments 10. The processor 50 calculates the real position of the robotic arm 100 based on the signals from the gyroscope sensors 20, compares the real position of the robotic arm 100 to the predetermined position information stored in the storage 40, thus determining whether a deviation exists between the real position of the robotic arm 100 and the predetermined position information. The processor 50 generates driving signals if a deviation exist between the real position of the robotic arm 100 and the predetermined position information. The driving motors 60 drive the arm segments 10 according to the driving signals to compensate for any deviation. The above step can be repeated until the movable 100 is precisely positioned corresponding to the predetermined position information.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A robotic arm position controlling device for controlling positioning of a robotic arm, the robotic arm including a plurality of articulated arm segments and a plurality of driving motors for driving the respective arm segments to move, the robotic arm position controlling device comprising:
a plurality of gyroscope sensors each configured for detecting a movement of the corresponding arm segment and generating an analog signal associated with the detected movement of the arm segment;
an A/D convertor electrically connected to the gyroscope sensors and configured for converting the analog signal to a digital signal;
a storage connected to the A/D convertor and configured for storing the converted digital signal and position information associated with predetermined positions of the arm segments;
a processor configured for determining the position of each of the arm segments based upon the converted digital signal, and determining if the position of each of the arm segments is deviated from the corresponding predetermined position, and controlling the driving motors to move the deviated arm segment to the predetermined position.

2. A robotic arm, comprising:
a plurality of movable articulated arm segments;
a plurality of driving motors for driving the respective arm segments to move; and
a robotic arm position controlling device comprising:
a plurality of gyroscope sensors each configured for detecting a movement of the corresponding arm segment and generating an analog signal associated with the detected movement of the arm segment;
an A/D convertor electrically connected to the gyroscope sensors and configured for converting the analog signal to a digital signal;
a storage connected to the A/D convertor and configured for storing the converted digital signal and position information associated with predetermined positions of the arm segments;
a processor configured for determining the position of each of the arm segments based upon the converted digital signal, and determining if the position of each of the arm segments is deviated from the corresponding predetermined position, and controlling the driving motors to move the deviated arm segment to the predetermined position.

3. The robotic arm of claim 2, further comprising a base, wherein the articulated arm segments comprises a first arm segment, a second arm segment and a third arm segment, one end of the first arm segment is movably connected to the base, the other end of the first arm segment is movably connected to one end of the second arm segment, one end of the third arm segment is movably connected to the other end of the second arm segment.

4. The robotic arm of claim 3, wherein an operating head is connected the a distal end of the third arm segment for performing a predetermined operational task.

5. The robotic arm of claim 2, wherein each of the gyroscope sensors is mounted on the corresponding arm segment adjacent to a distal end thereof.

6. The robotic arm of claim 2, wherein the diving motors are selected from the group consisting of stepping motors and linear motors.
